(19) United States
(12) Patent Application Publication
(10) Pub. No.: US 2014/0146800 A1
(43) Pub. Date: May 29, 2014

(54) METHOD FOR OPERATING WIRELESS NETWORK, RECORDING MEDIUM HAVING THE SAME RECORDED THEREON, AND MOBILE TERMINAL USING THE SAME

(71) Applicant: SAMSUNG ELECTRO-MECHANICS CO., LTD., Suwon (KR)

(72) Inventor: Ki Han HWANG, Suwon (KR)

(73) Assignee: SAMSUNG ELECTRO-MECHANICS CO., LTD., Suwon (KR)

(21) Appl. No.: 13/779,696

(22) Filed: Feb. 27, 2013

(30) Foreign Application Priority Data
Nov. 26, 2012 (KR) 10-2012-0134749

(51) Int. Cl. H04W 48/04

(52) U.S. Cl. CPC H04W 48/04
USPC 370/338

(57) ABSTRACT

There are provided a method for operating a wireless network performed in a mobile terminal wirelessly connected to a base station using a mobile network, the method including, receiving access point (AP) group information including at least one access point (AP) present within a predetermined distance from a location of the mobile terminal, from the base station, determining a first AP included in the AP group information if a wireless communications request is determined by applications driven in the mobile terminal, and performing a wireless communications connection according to the wireless communications request using the mobile network if it is determined that a connection between the first AP and the mobile terminal is invalid.

### CROSS-REFERENCE TO RELATED APPLICATIONS

This application claims the priority of Korean Patent Application No. 10-2012-0134749 filed on Nov. 26, 2012, in the Korean Intellectual Property Office, the disclosure of which is incorporated herein by reference.

### BACKGROUND OF THE INVENTION

1. Field of the Invention

The present invention relates to a method for operating a wireless network capable of considerably reducing power loss while stabilizing access to a mobile terminal by accessing an access point based on a location of a mobile terminal and performing wireless communications by automatically using a mobile network when the access is invalid, a recording medium having the same recorded thereon, and a mobile terminal using the same.

2. Description of the Related Art

Recently, with the epoch-making development of computers, electron communications technologies, various types of wireless network services have been provided through wireless networks.

Further, as the development of high-performance portable terminals, such as a smartphone, has accelerated, the need for access to various wireless networks has increased. That is, the recent mobile terminal may be connected to a wireless LAN or various wireless networks, such as, Bluetooth, ZigBee, and the like, in addition to mobile networks.

As a result, however, a problem in terms of the quality of a wireless network used in a plurality of networks and a power management problem of a mobile terminal are emerging. For example, when the wireless LAN access mode of a smartphone is activated, smartphone power may be excessively consumed due to an operation of periodically searching for an access point, and wireless communications may not be substantially made during the execution of connection, such that a quality of communications may be deteriorated.

The following related art document relates to a technology of operating a wireless network, but does not overcome the foregoing limitations.

### Related Art Document

(Patent Document 1) Korean Patent Laid-Open Publication No. 2012-0097934
(Patent Document 2) Korean Patent Laid-Open Publication No. 2011-0121435

### SUMMARY OF THE INVENTION

An aspect of the present invention provides a method for operating a wireless network capable of considerably reducing power loss while stabilizing access to a mobile terminal by accessing an access point based on a location of a mobile terminal and performing wireless communications by automatically using a mobile network when the access is invalid, a recording medium having the same recorded thereon, and a mobile terminal using the same.

According to an aspect of the present invention, there is provided a method for operating a wireless network performed in a mobile terminal wirelessly connected to a base station using a mobile network, the method including: receiving access point (AP) group information including at least one access point (AP) present within a predetermined distance from a location of the mobile terminal, from the base station; determining a first AP included in the AP group information if a wireless communications request is determined by applications driven in the mobile terminal; and performing a wireless communications connection according to the wireless communications request using the mobile network if it is determined that a connection between the first AP and the mobile terminal is invalid.

The receiving of the AP group information may include: receiving and storing the AP group information; and setting a priority of currently received AP group information to be higher and store the currently received AP group information if it is determined that pre-stored AP group information is present therein.

The receiving of the AP group information may include: if it is determined that the mobile terminal enters a coverage area of a new base station, providing location information on the mobile terminal to the new base station.

The determining of the AP may include determining the most recently stored AP as the first AP if it is determined that information on the plurality of APs is included in the AP group information.

The performing of the wireless communications connection may include forming the wireless communications connection between the first AP and the mobile terminal if it is determined that the connection between the first AP and the mobile terminal is valid and returning the formed wireless communications connection to the applications.

The performing of the wireless communications connection may include: determining that the connection between the first AP and the mobile terminal is valid by activating a wireless LAN function; and inactivating the wireless LAN function of the mobile terminal if it is determined that the connection between the first AP and the mobile terminal is invalid.

According to another aspect of the present invention, there is provided a method for operating a wireless network performed in a base station wirelessly connected to a mobile terminal using a mobile network, the method including: determining a location of the mobile terminal if it is determined that a connection of the mobile terminal is made within a coverage area of the base station; and selecting at least one AP present within a predetermined distance from the location of the mobile terminal in a preset AP database to generate AP group information.

The method for operating a wireless network may further include: determining whether the location of the mobile terminal is changed, and if the location of the mobile terminal is changed, re-selecting at least one AP present within the predetermined distance based on the changed location of the mobile terminal to re-generate the AP group information.

The AP database may include access information and location information on the at least one AP.

According to another aspect of the present invention, there is provided a mobile terminal wirelessly connected to a base station using a mobile network, the mobile terminal including: an application sensing unit sensing a wireless communications request by applications driven in the mobile terminal; an AP management unit receiving AP group information on at least one AP present within a predetermined distance from a location of the mobile terminal and when the wireless communications request is sensed by the application sensing unit, determining a first AP in the AP group information; and a communications control unit setting a wireless communications connection to one of a mobile network via the base station and a wireless network via the first AP according to whether a connection between the first AP and the mobile terminal is valid.

The AP management unit may include: an AP group information storage module receiving and storing the AP group information from the base station; and an AP selection module selecting one first AP of a plurality of APs included in the AP group information.

The AP management unit may further include: an access validity determination module determining validity of the wireless communications connection to the first AP, and the communications control unit performs the wireless communications connection to the mobile network if it is determined that the wireless communications connection to the first AP is invalid by the access validity determination module.

The AP selection module may select the first AP using the most recently stored AP group information.

The communications control unit may be connected to the first AP through a wireless LAN and inactivate a wireless LAN function of the mobile terminal if it is determined that the wireless communications connection to the first AP is invalid by the access validity determination module.

According to another aspect of the present invention, there is provided a recording medium having a program recorded thereon, the program executing a method for operating a wireless network and being driven in a mobile terminal wirelessly connected to a base station using a mobile network, the recording medium including: a function of receiving AP group information on at least one AP present within a predetermined distance form a location of the mobile terminal, from the base station; a function of determining a first AP included in the AP group information if a wireless communications request is determined by applications driven in the mobile terminal; and a function of performing a wireless communications connection according to the wireless communications request using the mobile network if it is determined that a connection between the first AP and the mobile terminal is invalid.

According to another aspect of the present invention, there is provided a recording medium having a program recorded thereon, the program executing a method for operating a wireless network and being driven in a base station wirelessly connected to a mobile terminal using a mobile network, the recording medium comprising: a function of determining a location of the mobile terminal if it is determined that a connection of the mobile terminal is made within a coverage area of the base station; and a function of selecting at least one AP present within a predetermined distance from the location of the mobile terminal in a preset AP database to generate AP group information.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a reference diagram illustrating a relationship between a mobile terminal, a base station, and an access point (AP), according to an embodiment of the present invention;

FIG. 2 is a configuration diagram for describing the base station according to the embodiment of the present invention;

FIG. 3 is a detailed configuration diagram for describing an embodiment of an AP group providing unit of FIG. 2;

FIG. 4 is a configuration diagram for describing the mobile terminal according to the embodiment of the present invention;

FIG. 5 is a detailed configuration diagram for describing an embodiment of an AP management unit of FIG. 4;

FIG. 6 is a flow chart for describing an operation among the base station, the mobile terminal, and the access point according to the embodiment of the present invention;

FIG. 7 is a flow chart for describing a method for operating a wireless network performed in a mobile terminal according to another embodiment of the present invention; and

FIG. 8 is a flow chart for describing a method for operating a wireless network performed in a base station according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

The present invention may be implemented as a computer-readable code in a computer-readable recording medium, and the computer-readable recording medium includes all types of recording apparatuses readable by a computer system. An example of the computer-readable recording medium may include a ROM, a RAM, a CD-ROM, a magnetic tape, a floppy disk, an optical data storage device, and the like, and may include ones implemented in a form of a carrier wave (for example, transmission through the Internet). Further, the computer-readable recording medium is distributed in a computer system connected to a network and also includes a form in which the computer-readable code is stored and performed based on a distribution type.

Hereinafter, a mobile network means a wireless network that performs mobile communications through a base station, such as a 2G network, a 3G network, a 4G network, a GSM network, and the like. Audio and data communications may be performed through the mobile network.

Further, an access point (hereinafter, referred to as AP) means an access point for performing wireless communications, not the mobile network. The AP is for a wireless LAN referred to as WiFi and includes all access points that may provide predetermined wireless communications such as Bluetooth, ZigBee, and the like.

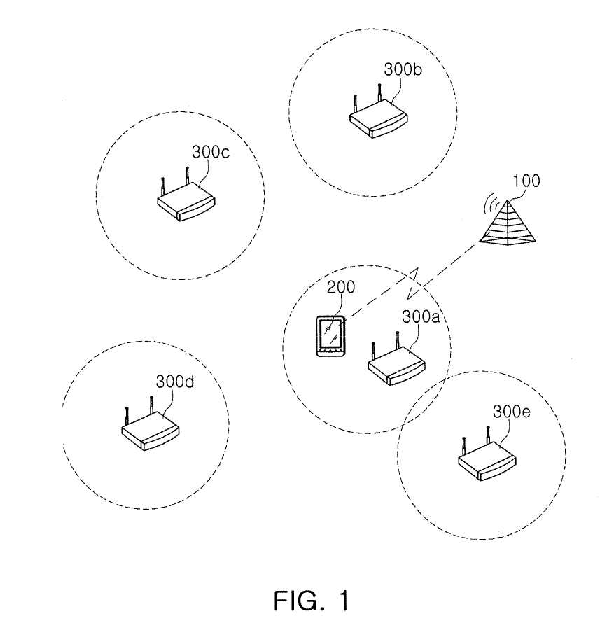

Hereinafter, embodiments of the present invention will be described in more detail with reference to FIGS. 1 to 8.

FIG. 1 is a reference diagram illustrating the relationship between a mobile terminal, a base station, and an access point (AP) according to an embodiment of the present invention.

Referring to FIG. 1, a mobile terminal 200 may be connected to a mobile network through a base station 100. Further, the mobile terminal 200 may be connected to a wireless network through APs 300a to 300e (hereinafter, denoted by 300).

The AP 300 may have a predetermined coverage (illustrated with a dotted circle) that connects the wireless networks. In the illustrated example, the mobile terminal 200 may be connected to the wireless network through the AP 300a.

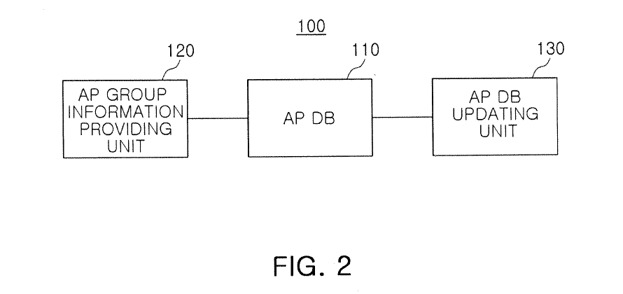

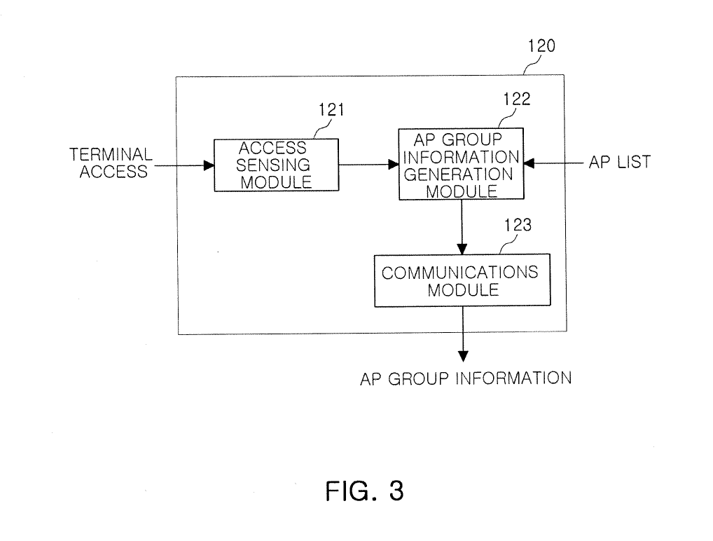

The base station 100 determines a location of the mobile terminal 200 and generates information on at least one AP (hereinafter, AP group information) to which the mobile terminal 200 may be connected. The base station 100 will be described in more detail with reference to FIGS. 2 and 3.

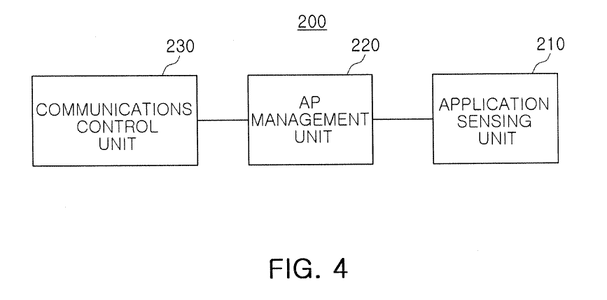

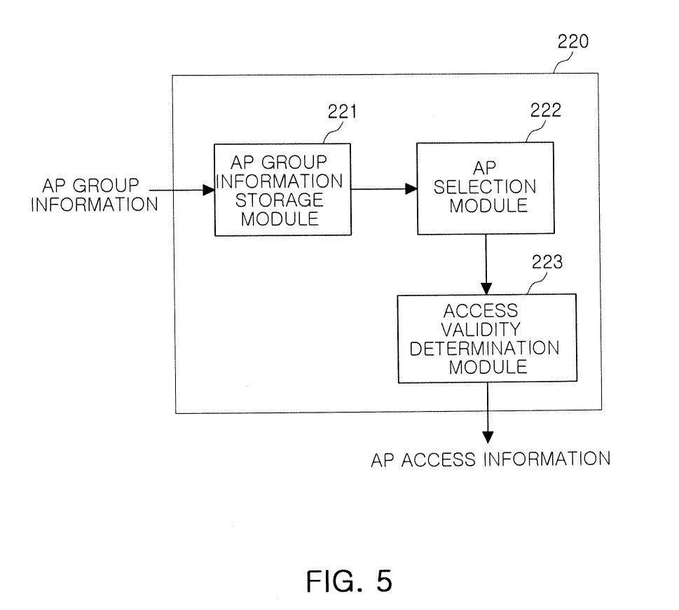

Further, the mobile terminal 200 may access a specific AP using the received AP group information to perform the wireless communications connection. The mobile terminal 200 may connect wireless communications using any one of the wireless networks through the mobile network and the AP. The mobile terminal 200 may place a priority on the wireless network through the AP to attempt the wireless communications connection. However, if it is determined that the wireless network through the AP is invalid, the mobile network through the base station 100 may be used. The mobile terminal 200 will be described below in more detail with reference to FIGS. 4 and 5.

FIG. 2 is a configuration diagram for describing the base station according to the embodiment of the present invention and FIG. 3 is a detailed configuration diagram for describing an embodiment of an AP group providing unit of FIG. 2. The base station 100 will be described below in more detail with reference to FIGS. 2 and 3.

Referring to FIGS. 2 and 3, the base station 100 may include an AP database (hereinafter, AP DB) 110 and an AP group information providing unit 120. According to the embodiment of the present invention, the base station 100 may further include an AP DB updating unit 130.

The AP DB 110 may store access information and location information on at least one AP. Further, the AP DB 110 may further store information on whether encryption for the corresponding AP is set, public/private information, and the like.

The AP group information providing unit 120 may compare the location of the mobile terminal 200 and locations of each AP stored in the AP DB 110 to generate the AP group information including at least one AP accessible by the mobile terminal 200.

In one embodiment of the present invention, the AP group information providing unit 120 may generate the AP group information in consideration of general AP coverage. That is, the AP coverage may be reflected in the location of the mobile terminal 200 to determine at least one accessible AP.

In one embodiment of the present invention, the AP group information providing unit 120 may determine the location of the corresponding mobile terminal 200 to generate the AP group information when it is determined that the access of the mobile terminal 200 is made within the AP coverage.

In one embodiment, when the location of the mobile terminal 200 moves, the AP group information providing unit 120 may re-generate the AP group information in consideration of the moved location and provide the re-generated AP group information to the mobile terminal 200. Described in more detail, the AP group information providing unit 120 determines whether the location of the mobile terminal 200 is changed and if so, may re-select at least one AP present within a predetermined distance based on the changed location of the mobile terminal 200 to re-generate the AP group information.

In one embodiment, the AP group information providing unit 120 may include an access sensing module 121, an AP group information generation module 122, and a communications module 123.

The access sensing module 121 may determine whether the mobile terminal 200 accesses a base station. When the mobile terminal 200 accesses the base station, the access sensing module 121 may provide the access to the AP group information generation module 122.

In one embodiment, the access sensing module 121 may interwork with the mobile terminal 200 to determine the location of the mobile terminal 200. Various types of location determination method may be performed, and therefore the present invention is not limited to a specific method.

In one embodiment, when the mobile terminal 200 accessing the base station 100 changes its own location while maintaining the access, the access sensing module 121 may sense the changed location and provide the sensed location to the AP group information generation module 122.

The AP group information generation module 122 may request an AP list to the AP DB 110 to generate the AP group information. When receiving the sensed information (access, location movement, location information, and the like) from the access sensing module 121, the AP group information generation module 122 may generate the AP group information based on the sensed information.

The AP group information generation module 122 may request the AP group information based on the location of the mobile terminal 200. That is, as described above, at least one AP that may be present within a predetermined distance based on the location of the mobile terminal 200 may be acquired from the AP DB 110 to generate the AP group information.

The communications module 123 may provide the AP group information provided from the AP group information generation module 122 to the corresponding mobile terminal 200.

The AP DB updating unit 130 may update the AP DB 110. When a new AP is registered or the location movement of the AP, the removal of the AP, and the like, are generated, the AP DB updating unit 130 may reflect these aspects to update the AP DB 110.

FIG. 4 is a configuration diagram for describing the mobile terminal according to the embodiment of the present invention and FIG. 5 is a detailed configuration diagram for describing an embodiment of an AP management unit of FIG. 4.

Hereinafter, the mobile terminal 200 will be described below in more detail with reference to FIGS. 4 and 5.

Referring to FIGS. 4 and 5, the mobile terminal 200 may include an application sensing unit 210, an AP management unit 220, and a communications control unit 230.

The application sensing unit 210 may sense a wireless communications request by applications driven in the mobile terminal 200. The present invention may perform operations to be described below when the wireless communications request is performed by the applications. That is, when the applications of the mobile terminal 200 do not perform the wireless communications request, the applications do not perform any functions, such that the power efficiency of the mobile terminal 200 may be increased.

The AP management unit 220 may receive the AP group information on at least one AP present within a predetermined distance from a location of the mobile terminal 200.

The AP group information may be provided as a top-down method by the base station 100 and alternatively, may be provided by a down-up method that allows the AP management unit 220 to request the base station 100. Alternatively, the AP group information may be provided using both of the top-down method and the down-up method.

When the application sensing unit 210 senses the wireless communications request, the AP management unit 220 may determine any one AP (hereinafter, first AP) from the AP group information.

Described in more detail with reference to FIG. 5, the AP management unit 220 may include an AP group information storage module 221 and an AP selection module 222. In one embodiment, the AP management unit 220 may further include an access validity determination module 223.

The AP group information storage module 221 may receive and store the AP group information from the base station 100. To this end, the AP group information storage module 221 may include a predetermined storage unit.

When a request to the AP selection module 222 is present, the AP group information storage module 221 may provide the AP group information.

In one embodiment, the AP group information storage module 221 may allocate a priority to manage the AP group information. Described in more detail, if the pre-stored AP group information is present therein, the AP group information storage module 221 may set a priority of the currently received AP group information to be higher to store the information.

In one embodiment, the AP group information storage module 221 may request the new AP group information to the base station 100, when the mobile terminal 200 moves. For example, when the mobile terminal 200 enters the coverage of a new base station, the AP group information storage module 221 may provide the location information of the mobile terminal 200 to a new base station. The case corresponds to an example in which the AP group information is updated by the foregoing down up method.

The AP selection module 222 may select a first AP among the plurality of APs included in the AP group information.

In one embodiment, the AP selection module 222 may use the priority of the AP group information to determine the first AP. Described in more detail, when the information on the plurality of APs is included in the AP group information, the AP selection module 222 may determine the most recently stored AP as the first AP.

The access validity determination module 223 may determine the validity of the wireless communications connection to the determined first AP. For example, the access validity determination module 223 may compare signal strength, a bandwidth, and the like, of the first AP with a preset threshold value to determine the validity of the wireless communications connection.

The communications control unit 230 may perform the wireless communications connection to any one of the mobile network via the base station 100 or the wireless network via the first AP according to whether the connection between the first AP and the mobile terminal is valid.

In one embodiment, the communications control unit 230 may place the priority on the wireless network via the first AP to perform the wireless communications connection. Describing in more, if it is determined that the connection to the first AP is valid, the communications control unit 230 forms the wireless communications connection and return the formed wireless communications connection to the applications of the mobile terminal 200.

In one embodiment, the communications control unit 230 may inactivate the wireless access setting for the first AP if it is determined that the connection to the first AP is invalid. Describing the first AP that is the AP of the wireless LAN, by way of example, the communications control unit 230 may activate a wireless LAN function and use the access validity determination module 223 to determine whether the connection to the first AP is valid. If it is determined that the connection to the first AP is valid, the communications control unit 230 may inactivate the wireless LAN function of the mobile terminal 200. As described above, the present invention may block the ineffective access attempts to improve the power supply management and the wireless communications environment of the mobile terminal 200.

In one embodiment, when the wireless communications connection to the first AP is invalid by the access validity determination module 223, the communications control unit 230 may use the base station 100 to perform the wireless communications connection to the mobile network. Further, in one embodiment, the communications control unit 230 may return the wireless communications connection with the connected mobile network to applications of the mobile terminal 200.

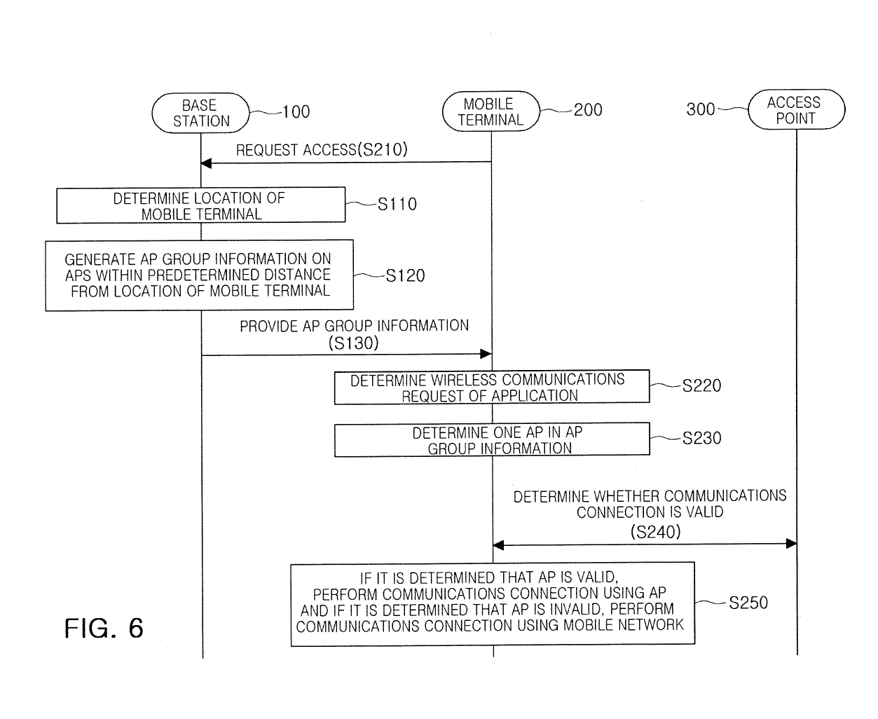

FIG. 6 is a flow chart for describing an operation among the base station, the mobile terminal, and the access point according to the embodiment of the present invention. An example illustrated in FIG. 6 relates to an example in which the AP group information is provided by the top-down method.

Referring to FIG. 6, the mobile terminal 200 may request access to the mobile network to the base station 100 (S210).

The base station 100 determines the location of the mobile terminal 200 (S110) and selects information on at least one AP within a predetermined distance from the location of the mobile terminal 200 to generate the AP group information (S120) and provide the generated AP group information to the mobile terminal 200 (S130).

If the mobile terminal 200 determines the wireless communications request of applications (S220), the mobile terminal 200 may determine any one first AP from the AP group information (S230).

The mobile terminal 200 determines whether the communications connection to the first AP 300 is valid (S240) and when if it is determined that the first AP 300 is valid, the mobile terminal 200 may use the first AP to perform the wireless communications connection with the wireless network. If it is determined that the first AP 300 is invalid, the mobile terminal 200 may use the mobile network to perform the wireless communications connection.

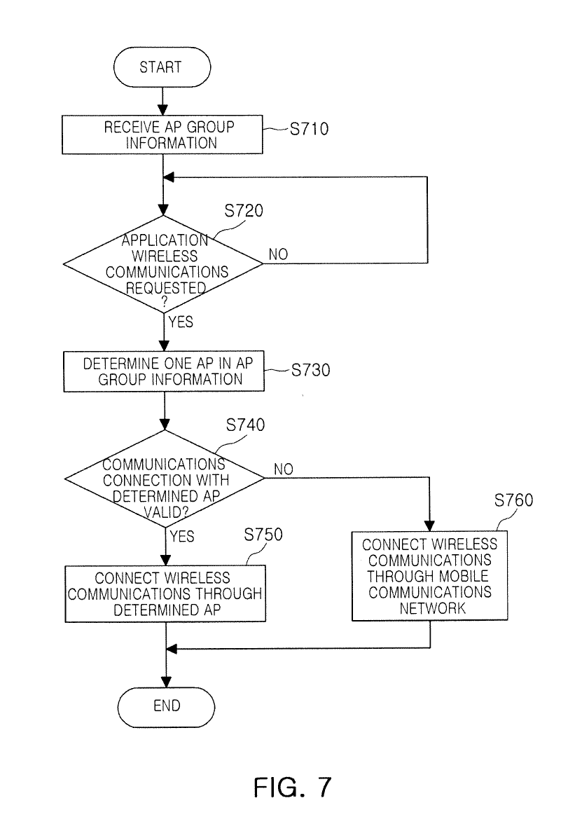

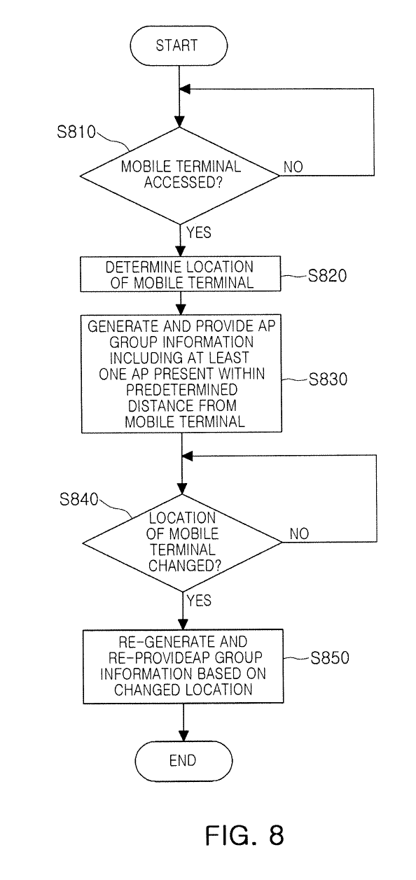

An example of FIG. 6 relates to an example of the foregoing description. Therefore, the method for operating a wireless network performed in the mobile terminal 200 and the base station 100 will be described below in more detail with reference to FIGS. 7 and 8.

FIG. 7 is a flow chart for describing a method for operating a wireless network performed in a mobile terminal according to another embodiment of the present invention.

Referring to FIG. 7, the mobile terminal 200 may receive the AP group information including the mobile terminal 200 and at least one access point (AP) present within a predetermined distance from the location of the mobile terminal 200, from the base station 100 (S710).

If the mobile terminal 200 determines the wireless communications request (S720, YES) by the applications driven in the mobile terminal 200, the mobile terminal 200 may determine anyone (first AP) among the plurality of APs included in the AP group information (S730).

The mobile terminal 200 determines whether the connection with the first AP is valid (S740) and if it is determined that the connection with the first AP is invalid (S740, No), may use the mobile network to perform the wireless communications connection according to the wireless communications request using the mobile network.

Alternatively, when the connection with the first AP is valid (S740, YES), the mobile terminal 200 may perform the wireless communications connection through the first AP.

The mobile terminal 200 may provide the connected wireless communications connection to the applications.

In one embodiment of the receiving of the AP group information (S710), the mobile terminal 200 receives and stores the AP group information and if the pre-stored AP group information is present therein, the priority of the currently received AP group information may be set to be higher and stored.

In another embodiment of the receiving of the AP group information (S710), when the mobile terminal 200 enters the coverage of the new base station, the mobile terminal 200 may provide the location information of the mobile terminal 200 to a new base station.

In one embodiment of the determining of the AP (S730), the mobile terminal 200 may determine the most recently stored AP as the first AP when the information on the plurality of APs is included in the AP group information.

In one embodiment of the performing of the wireless communications connection (S740 to S760), the mobile terminal 200 forms the wireless communications connection with the first AP if it is determined that the connection with the first AP is valid and may return the formed wireless communications connection to the applications.

In one embodiment of the performing of the wireless communications connection (S740 to S760), the mobile terminal 200 activates the wireless LAN function to determine whether the connection with the first AP is valid and may inactivate the wireless LAN function if it is determined that the connection with the first AP is invalid.

FIG. 8 is a flow chart for describing a method for operating a wireless network performed in a base station according to an embodiment of the present invention.

Referring to FIG. 8, if the base station 100 determines the access of the mobile terminal 200 within the coverage of the base station 100 (S810, YES), the base station 100 may determine the location of the mobile terminal 200 (S820).

The base station 100 may select at least one AP that is present within a predetermined distance from the location of the mobile terminal 200 in the pre-established AP database to generate the AP group information and provide the generated AP information to the mobile terminal 200 (S830).

The base station 100 determines whether the location of the mobile terminal 200 is changed (S840) and if so (S840, YES), may re-select at least one AP present within a predetermined distance based on the changed position of the mobile terminal 200 to re-generate the AP group information.

Referring to FIGS. 7 and 8, the method for operating a wireless network may be configured as a predetermined program. Therefore, it is apparent that the present invention may have a right scope as disclosed in claims even in connection with the recording medium having a program recorded thereon, the program executing a method for operating a wireless network.

As set forth above, according to the embodiment of the present invention, the power loss can be considerably reduced while stabilizing the access of the mobile terminal, by accessing the access point based on the location of the mobile terminal and performing the wireless communications by automatically using the mobile network when the access is invalid.

While the present invention has been shown and described in connection with the embodiments, it will be apparent to those skilled in the art that modifications and variations can be made without departing from the spirit and scope of the invention as defined by the appended claims.

What is claimed is:

1. A method for operating a wireless network performed in a mobile terminal wirelessly connected to a base station using a mobile network, the method comprising:
receiving access point (AP) group information including at least one access point (AP) present within a predetermined distance from a location of the mobile terminal, from the base station;
determining a first AP included in the AP group information if a wireless communications request is determined by applications driven in the mobile terminal; and
performing a wireless communications connection according to the wireless communications request using the mobile network if it is determined that a connection between the first AP and the mobile terminal is invalid.

2. The method of claim 1, wherein the receiving of the AP group information includes:
receiving and storing the AP group information; and
setting a priority of currently received AP group information to be higher and store the currently received AP group information if it is determined that pre-stored AP group information is present therein.

3. The method of claim 1, wherein the receiving of the AP group information includes:
if it is determined that the mobile terminal enters a coverage area of a new base station, providing location information on the mobile terminal to the new base station.

4. The method of claim 1, wherein the determining of the AP includes:
determining the most recently stored AP as the first AP if it is determined that information on the plurality of APs is included in the AP group information.

5. The method of claim 1, wherein the performing of the wireless communications connection includes forming the wireless communications connection between the first AP and the mobile terminal if it is determined that the connection between the first AP and the mobile terminal is valid and returning the formed wireless communications connection to the applications.

6. The method of claim 1, wherein the performing of the wireless communications connection includes:
determining that the connection between the first AP and the mobile terminal is valid by activating a wireless LAN function; and
inactivating the wireless LAN function of the mobile terminal if it is determined that the connection between the first AP and the mobile terminal is invalid.

7. A method for operating a wireless network performed in a base station wirelessly connected to a mobile terminal using a mobile network, the method comprising:
determining a location of the mobile terminal if it is determined that a connection of the mobile terminal is made within a coverage area of the base station; and
selecting at least one AP present within a predetermined distance from the location of the mobile terminal in a preset AP database to generate AP group information.

8. The method of claim 7, further including:
determining whether the location of the mobile terminal is changed, and if the location of the mobile terminal is changed, re-selecting at least one AP present within the predetermined distance based on the changed location of the mobile terminal to re-generate the AP group information.

9. The method of claim 7, wherein the AP database includes access information and location information on the at least one AP.

10. A mobile terminal wirelessly connected to a base station using a mobile network, the mobile terminal comprising:
an application sensing unit sensing a wireless communications request by applications driven in the mobile terminal;
an AP management unit receiving AP group information on at least one AP present within a predetermined distance from a location of the mobile terminal and when the wireless communications request is sensed by the application sensing unit, determining a first AP in the AP group information; and
a communications control unit setting a wireless communications connection to one of a mobile network via the base station and a wireless network via the first AP according to whether a connection between the first AP and the mobile terminal is valid.

11. The mobile terminal of claim 10, wherein the AP management unit includes:
an AP group information storage module receiving and storing the AP group information from the base station; and
an AP selection module selecting one first AP of a plurality of APs included in the AP group information.

12. The mobile terminal of claim 11, wherein the AP management unit further includes:
an access validity determination module determining validity of the wireless communications connection to the first AP,
the communications control unit performs the wireless communications connection to the mobile network if it is determined that the wireless communications connection to the first AP is invalid by the access validity determination module.

13. The mobile terminal of claim 11, wherein the AP selection module selects the first AP using the most recently stored AP group information.

14. The mobile terminal of claim 12, wherein the communications control unit is connected to the first AP through a wireless LAN, and
the communications control unit inactivates a wireless LAN function of the mobile terminal if it is determined that the wireless communications connection to the first AP is invalid by the access validity determination module.

15. A recording medium having a program recorded thereon, the program executing a method for operating a wireless network and being driven in a mobile terminal wirelessly connected to a base station using a mobile network, the recording medium comprising:
a function of receiving AP group information on at least one AP present within a predetermined distance form a location of the mobile terminal, from the base station;
a function of determining a first AP included in the AP group information if a wireless communications request is determined by applications driven in the mobile terminal; and
a function of performing a wireless communications connection according to the wireless communications request using the mobile network if it is determined that a connection between the first AP and the mobile terminal is invalid.

16. A recording medium having a program recorded thereon, the program executing a method for operating a wireless network and being driven in a base station wirelessly connected to a mobile terminal using a mobile network, the recording medium comprising:
a function of determining a location of the mobile terminal if it is determined that a connection of the mobile terminal is made within a coverage area of the base station; and
a function of selecting at least one AP present within a predetermined distance from the location of the mobile terminal in a preset AP database to generate AP group information.
